(19) United States
(12) Patent Application Publication
(10) Pub. No.: US 2025/0004220 A1
(43) Pub. Date: Jan. 2, 2025

(54) PHOTONIC INTEGRATED CIRCUIT AND OPTICAL COUPLER DESIGNS FOR IMPROVING PROCESS TOLERANCE

(71) Applicant: Intel Corporation, Santa Clara, CA (US)

(72) Inventors: Sufi R. Ahmed, Chandler, AZ (US); Shan Zhong, Chandler, AZ (US); Eric J. M. Moret, Beaverton, OR (US); Yang Wu, Chandler, AZ (US)

(73) Assignee: Intel Corporation, Santa Clara, CA (US)

(21) Appl. No.: 18/346,039

(22) Filed: Jun. 30, 2023

(51) Int. Cl. G02B 6/42

(52) U.S. Cl. CPC G02B 6/4243; G02B 6/4214; G02B 6/4239; G02B 6/425; G02B 6/428

(57) ABSTRACT

Photonic integrated circuits and optical couplers with improved process tolerance, and methods of forming the same, are disclosed herein. In one example, an integrated circuit package includes a photonic integrated circuit (PIC) to send or receive optical signals and an optical coupler to optically couple the PIC to one or more optical fibers. The PIC includes a first interface with at least two recesses and one or more grooves positioned between the recesses, and the optical coupler includes a second interface with at least two protrusions and one or more ridges positioned between the protrusions (or vice versa). The protrusions on the optical coupler are mated with the recesses on the PIC, and the ridges on the optical coupler are mated with the grooves on the PIC.

### BACKGROUND

High-speed optical interconnects are crucial to meet the continuously increasing data rate demands of modern data centers and computing systems. For example, traditional computing components can be packaged with optical interfaces to enable them to communicate over high-speed optical interconnects rather than traditional electrical interconnects. An optical interface typically includes a photonic integrated circuit (PIC) to send and receive optical signals over optical fibers. This requires the PIC to be optically coupled to the fibers, either directly or indirectly, which in turn requires precise alignment between the PIC, the optical fibers, and/or any intervening components used to optically couple the PIC to the optical fibers. In some cases, however, the requisite degree of alignment may not be achieved due to process variations during manufacturing.

### BRIEF DESCRIPTION OF THE DRAWINGS

FIGS. 1A-D illustrate an example of an optical interface with an extended ledge optical coupler.

FIG. 2 illustrates an example of an optical interface with alignment features having disproportionate dimensions.

FIG. 3 illustrates an example of an optical interface with locking mechanisms and alignment features having disproportionate dimensions.

FIGS. 4A-B illustrate an example of a photonic integrated circuit and an optical coupler with locking mechanisms and alignment features having disproportionate dimensions.

FIG. 5 illustrates an example of an optical interface with locking mechanisms and monolithic alignment features.

FIGS. 6A-B illustrate an example embodiment of an optical package in accordance with certain embodiments.

FIG. 7 illustrates a process flow for forming an optical package in accordance with certain embodiments.

FIG. 8 is a top view of a wafer and dies that may be included in a microelectronic assembly, in accordance with any of the embodiments disclosed herein.

FIG. 9 is a cross-sectional side view of an integrated circuit device that may be included in a microelectronic assembly, in accordance with any of the embodiments disclosed herein.

FIG. 10 is a cross-sectional side view of an integrated circuit device assembly that may include a microelectronic assembly, in accordance with any of the embodiments disclosed herein.

FIG. 11 is a block diagram of an example electronic device that may include a microelectronic assembly, in accordance with any of the embodiments disclosed herein.

### DETAILED DESCRIPTION

High-speed optical interconnects are crucial to meet the continuously increasing data rate demands of modern data centers and computing systems. For example, traditional computing components (e.g., processors, accelerators, FPGAs, switches, memory/storage, other ASIC nodes) can be packaged with optical interfaces to enable them to communicate over high-speed optical interconnects rather than traditional electrical interconnects. An optical interface typically uses a photonic integrated circuit (PIC) to send and receive optical signals over optical fibers. This requires the PIC to be optically coupled to the fibers, either directly or indirectly, which in turn requires precise alignment between the PIC, the optical fibers, and/or any intervening components used to optically couple the PIC to the optical fibers.

In some cases, for example, an optical coupler may be used to optically couple a PIC to a fiber cable. In particular, the optical coupler may have an interface attached to the PIC and another interface designed to mate with the fiber cable. As an example, the optical coupler may have a pluggable optical socket and the fiber cable may have a corresponding plug or ferrule connector designed to mate with the optical socket. This configuration requires the waveguides in the optical coupler to be precisely aligned with corresponding waveguides in the PIC and the fibers in the fiber cable. In some cases, however, the requisite degree of alignment may not be achieved due to process variations during manufacturing.

Accordingly, this disclosure presents embodiments of optical couplers and PICS designed to improve process tolerance, including embodiments with an extended ledge coupler, locking mechanisms, grooves/ridges with disproportionate or irregular dimensions, and/or a monolithic groove/ridge.

In some embodiments, for example, an optical coupler may be designed with an extended ledge for attachment to the PIC. For example, the extended ledge may be designed to extend over, and attach to, a relatively large portion of the PIC (e.g., beyond the PIC V-grooves) to provide support. In this manner, the load on the optical coupler is distributed more evenly over the extended ledge, which minimizes tilt from the cantilever effect. Further, the adhesive used to attach the optical coupler to the PIC remains underneath the extended ledge (e.g., due to its length) instead of bulging on top of the optical coupler.

In some embodiments, the optical coupler and the PIC may have locking mechanisms (e.g., locking recesses and protrusions on the mating surfaces) to anchor the optical coupler to the PIC and provide passive alignment. For example, the PIC die may have shallow recesses on its surface (e.g., holes in the shape of a square, circle, etc.), while the optical coupler may have corresponding protrusions on its surface (e.g., square or round pegs) that are designed to mate with the recesses on the PIC. Moreover, the bottom of the recesses on the PIC may include reflow compatible flexible polymer pads, which provide conformal passive alignment for tilt and height variation. In this manner, the locking mechanisms increase the tolerance to stress and reduce the risk of misalignment during subsequent assembly processes. As an example, when attaching or detaching a fiber cable to or from the optical coupler (e.g., by plugging a ferrule on the fiber cable into, or unplugging the ferrule from, the receptacle/socket on the coupler), the locking mechanisms minimize coupler movement and reduce the probability of misalignment.

In some embodiments, the inner ridges on the optical coupler may be designed with smaller dimensions than the outer ridges, which increases tolerance for dimensional variation and reduces the impact of foreign material trapped between the ridges/grooves on the coupler and PIC. For example, the outer ridges on the optical coupler may be designed with similar dimensions as the corresponding grooves on the PIC, but the inner ridges may be designed with disproportionately smaller dimensions. In this manner, if process variations during manufacturing cause any of the inner ridges on the optical coupler to be larger than intended (or any of the inner grooves on the PIC to be smaller than intended), those ridges will still fit within the corresponding grooves on the PIC with the proper alignment. Similarly, if any foreign material becomes trapped between the inner ridges and grooves on the optical coupler and the PIC, the foreign material is less likely to impact alignment due to the smaller size of the inner ridges on the coupler.

In some embodiments, the optical coupler and the PIC may include the locking mechanisms described above, along with disproportionately sized ridges and grooves. For example, all of the ridges on the optical coupler may be designed with disproportionately smaller dimensions than the corresponding grooves on the PIC. In this manner, the locking mechanisms anchor the optical coupler to the PIC to provide the requisite degree of alignment, while the disproportionately sized ridges/grooves on the coupler/PIC increase tolerance for dimensional variation and reduce the impact of foreign material trapped within the ridges/grooves, without impacting the optical properties of the coupler or the waveguides.

In some embodiments, the optical coupler and the PIC may include the locking mechanisms described above, along with monolithic structures for waveguide alignment. For example, the optical coupler may have a monolithic ridge or protrusion and the PIC may have a monolithic groove or trench (or vice versa), and these monolithic structures may be designed to mate in order to align the waveguides in the optical coupler and the PIC. In this manner, the monolithic structures align all waveguides in the optical coupler and the PIC while providing better mechanical integrity than individual grooves and ridges, and the locking mechanisms anchor the optical coupler to the PIC to maintain the requisite degree of alignment.

These embodiments provide various advantages, including improved process tolerance, which translates into higher yield and lower costs. In particular, these optical coupler and PIC designs are more robust to process variations that can impact alignment, such as optical coupler tilt caused by the cantilever effect, adhesive bulging at the attachment point between the optical coupler and the PIC, unintended variations in dimensions of grooves/ridges used for waveguide alignment, foreign material trapped between grooves/ridges, and stress during subsequent assembly processes, among other examples. Further, these embodiments can be applied to other optical components that require optical coupling beyond PICS and optical couplers.

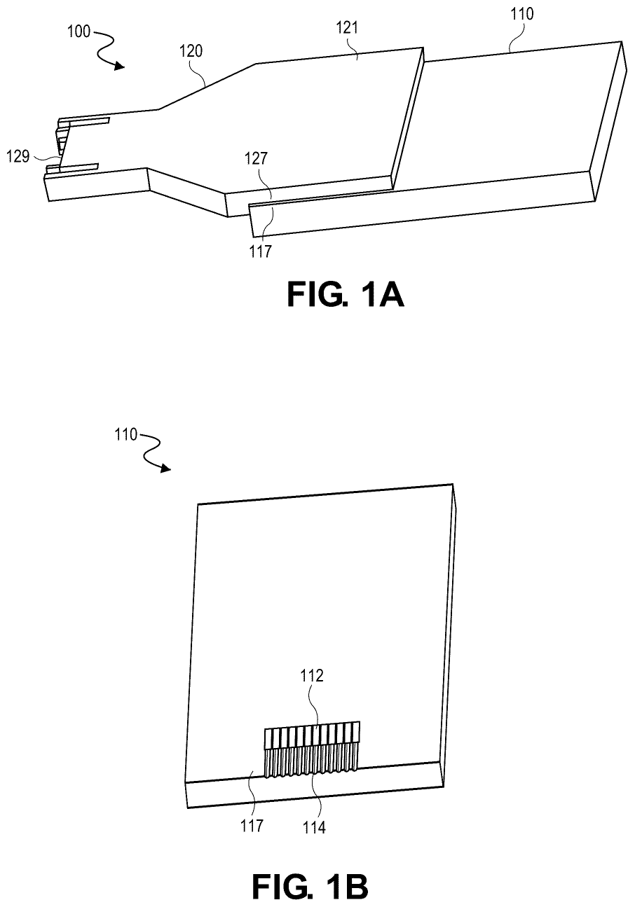

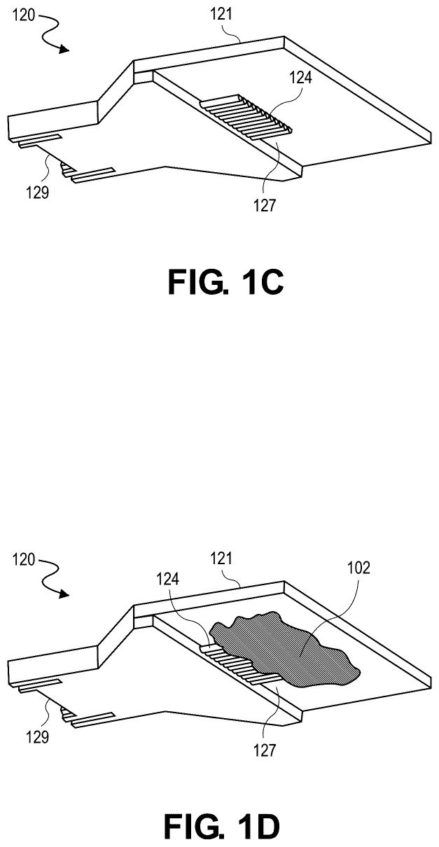

FIGS. 1A-D illustrate an example of an optical interface 100 with a photonic integrated circuit (PIC) 110 and an extended ledge optical coupler 120. In the illustrated example, the optical interface 100 is shown in FIG. 1A with the PIC 110 and the extended ledge optical coupler 120, the PIC 110 is shown in FIG. 1B, and the extended ledge optical coupler 120 is shown in FIGS. 1C and 1D without and with adhesive, respectively.

In the illustrated embodiment, the optical interface 100 includes the PIC 110 and the extended ledge optical coupler 120, as shown in FIG. 1A. The PIC 110 is used to send and receive optical signals over a fiber cable (not shown), and the optical coupler 120 is used to connect, or optically couple, the fiber cable to the PIC 110.

As shown in FIG. 1B, the PIC 110 includes an interface 117 with waveguides 112 and alignment grooves 114 (e.g., V-grooves) on the top surface of the die, which is designed to mate with a corresponding interface 127 on the optical coupler 120.

As shown in FIG. 1C, the optical coupler 120 includes multiple interfaces 127, 129 and an extended ledge or shelf 121, along with waveguides (not shown) extending between the respective interfaces 127, 129. The first interface 127 is underneath the extended ledge 121 and is designed to mate with the corresponding interface 117 on the top surface of the PIC 110. For example, the first interface 127 includes alignment ridges 124 with embedded waveguides (not shown) under the extended ledge 121, which are designed to mate with the alignment grooves 114 on the PIC 110. In this manner, when the alignment ridges 124 on the optical coupler 120 mate with the alignment grooves 114 on the PIC 110, the waveguides in the optical coupler 120 align with the waveguides 112 in the PIC 110. Moreover, the second interface 129 has mating/alignment features and waveguides (not shown) for mating with a fiber cable.

As shown in FIG. 1A, the ledge 121 on the optical coupler 120 attaches to the top of the PIC 110, which enables the alignment ridges 124 on the coupler 120 to interface with the alignment grooves 114 on the PIC 110. The rest of the optical coupler 120 hangs off the PIC 110, however, which creates a cantilever effect. In some designs, the cantilever effect may cause the optical coupler to tilt, which can potentially lead to misalignment between the coupler and the PIC, particularly if the ledge of the coupler is relatively short compared to the rest of the coupler. In the illustrated embodiment, however, the ledge 121 of the optical coupler 120 is relatively long and extends over a large portion of the PIC 110 to provide more support. For example, the coupler ledge 121 extends past the end of the V-grooves 114 on the PIC 110 and up to the area where the waveguides 112 are located. In this manner, the extended ledge 121 provides additional weight and better load distribution, which minimizes tilt from the cantilever effect.

Further, the optical coupler 120 is attached to the PIC 110 using an adhesive, such as an index-matching epoxy (IME). If the coupler ledge is too short, however, the adhesive may bulge up along the edge of the coupler during the attach, which can interfere with subsequent processes (e.g., the substrate attach), particularly if the adhesive bulges above the coupler. In the illustrated embodiment, however, the length of the extended ledge 121 prevents the adhesive 102 from bulging up above the coupler 120. As a result, the adhesive 102 remains underneath the extended ledge 121 of the coupler 120, as shown in FIG. 1D.

It should be appreciated that optical interface 100 is merely presented as an example embodiment. In other embodiments, certain components or features may be omitted, added, rearranged, modified, or combined. In some embodiments, for example, the respective mating and alignment features on the PIC 110 and the optical coupler 120 may be reversed or modified. For example, while the PIC 110 includes alignment grooves 114 and the optical coupler 120 includes alignment ridges 124 in the illustrated embodiment, in other embodiments the PIC 110 may include alignment ridges and the optical coupler 120 may include alignment grooves. As another example, while the optical coupler 120 includes an extended ledge 121 in the illustrated embodiment, in other embodiments the PIC 110 may include an extended ledge. As another example, the alignment grooves 114 and ridges 124 may have other shapes different from those shown in the illustrated embodiment. Further, in some embodiments, the PIC 110 and the optical coupler 120 may include other mating and alignment features instead of, or in addition to, alignment grooves/ridges and an extended ledge, such as features with different shapes or different types of features altogether. In some embodiments, the number of certain features on the PIC 110 and the optical coupler 120 may vary, such as the number of grooves, ridges, or waveguides. In addition, optical interface 100 may be modified or combined with aspects of any of the other embodiments described herein (e.g., an extended ledge/shelf, locking mechanisms, waveguide alignment features with varying dimensions, monolithic waveguide alignment features). Further, in some embodiments, optical interface 100 may include additional components, such as one or more electronic integrated circuits (EICs) (e.g., EIC 606, XPU 608, memory), substrates (e.g., package substrate 602), and so forth.

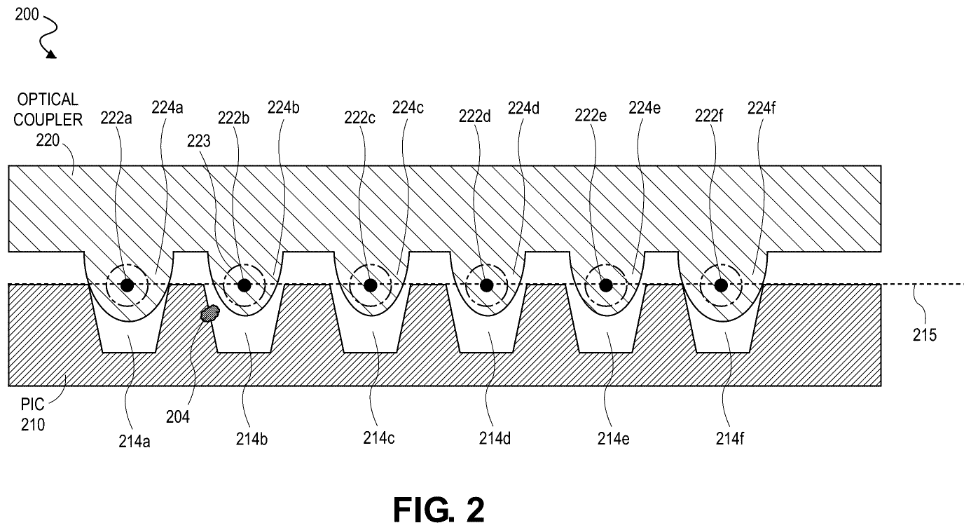

FIG. 2 illustrates an example of an optical interface 200 with alignment features having disproportionate dimensions. In the illustrated embodiment, for example, the optical coupler 220 has inner ridges 224b-e with smaller dimensions than its outer ridges 224a,f to increase tolerance for dimensional variation and reduce the impact of foreign material, as described below.

In the illustrated embodiment, optical interface 200 includes a photonic integrated circuit (PIC) 210 and an optical coupler 220. Moreover, the PIC 210 and the optical coupler 220 include alignment grooves 214a-f and alignment ridges 224a-f, respectively, to align the waveguides 222a-f in the optical coupler 220 with the waveguides (not shown) in the PIC 210. In particular, the waveguides in the PIC 210 are aligned along the optical axis 215 of the PIC 210, but in the illustrated view, they are occluded or hidden behind the ridges 224a-f and waveguides 222a-f on the coupler 220, which are also aligned along the optical axis 215 of the PIC 210.

In some designs, the PIC and the optical coupler may have grooves and ridges with similar dimensions—where the grooves on the PIC are only slightly larger than the ridges on the optical coupler—to enable the ridges to slide within the grooves for passive alignment. These designs are very sensitive to dimensional variation and foreign material (e.g., particles), however, which can lead to misalignment. For example, if process variations during manufacturing cause any of the ridges on the optical coupler to be larger than intended, or any of the grooves on the PIC to be smaller than intended, the ridges and grooves may be unable to mate with the proper alignment. Similarly, if any foreign material becomes trapped between the ridges and grooves, the foreign material may impede the ridges and grooves from mating with the proper alignment. As a result, the waveguides in the optical coupler may be misaligned with the optical axis of the PIC.

In the illustrated embodiment, however, the inner ridges 224b-e of the optical coupler 220 are designed with smaller dimensions than the outer ridges 224a,f to increase process tolerance. In particular, the outer ridges 224a,f of the optical coupler 220 are designed with similar dimensions as the grooves 214a-f on the PIC 210, which provides passive alignment for all ridges 224a-f on the optical coupler 220 to ensure they are properly aligned with the optical axis 215 when they mate with the grooves 214a-f on the PIC 210. However, the inner ridges 224b-e of the optical coupler 220 are designed with disproportionately smaller dimensions than the grooves 214a-f on the PIC 210, which increases tolerance for dimensional variation and reduces the impact of foreign material 204 during manufacturing.

For example, if process variations during manufacturing cause any of the inner ridges 224b-e on the coupler 220 to be larger than intended, or any of the inner grooves 214b-e on the PIC 210 to be smaller than intended, the inner ridges 224b-e will still be able to mate with the inner grooves 214b-e with proper alignment (and force feedback can be used to correct for any die tilt or misalignment). Similarly, if any foreign material 204 becomes trapped between the inner ridges 224b-e and grooves 214b-e, the foreign material 204 is less likely to impact alignment due to the smaller dimensions of the inner ridges 224b-c.

Moreover, reducing the dimensions of the inner ridges 224b-e has no negative impact on alignment or optical propagation. In particular, the dimensions of the inner ridges 224b-e can be reduced without impacting alignment since the full-size outer ridges 224a,f provide passive alignment. Further, the dimensions of the inner ridges 224b-e can be reduced without impacting optical propagation as long as the mode field diameter (MFD) 223 of the waveguides 222a-f remains within the ridges 224b-e. In some embodiments, for example, the MFD 223 of the waveguides 222a-f may be approximately 6.5 microns (μm), which means an inner ridge diameter of at least 6.5 μm should be sufficient for optical propagation.

It should be appreciated that optical interface 200 is merely presented as an example embodiment. In other embodiments, certain components or features may be omitted, added, rearranged, modified, or combined. In some embodiments, for example, the respective mating and alignment features on the PIC 210 and the optical coupler 220 may be reversed or modified. For example, while the PIC 210 includes alignment grooves 214a-f and the optical coupler 220 includes alignment ridges 224a-f in the illustrated embodiment, in other embodiments the PIC 210 may include alignment ridges and the optical coupler 220 may include alignment grooves. As another example, while the dimensions of the inner ridges 224b-e of the optical coupler 220 are reduced in the illustrated embodiment, in other embodiments the dimensions of the inner grooves 214b-e of the PIC 210 may be enlarged. As another example, the alignment grooves 214a-f and ridges 224a-f may have other shapes different from those shown in the illustrated embodiment. Further, in some embodiments, the PIC 210 and the optical coupler 220 may include other mating and alignment features instead of, or in addition to, alignment grooves/ridges, such as features with different shapes or different types of features altogether. In some embodiments, the number of certain features on the PIC 210 and the optical coupler 220 may vary, such as the number of grooves, ridges, or waveguides. In addition, optical interface 200 may be modified or combined with aspects of any of the other embodiments described herein (e.g., an extended ledge/shelf, locking mechanisms, waveguide alignment features with varying dimensions, monolithic waveguide alignment features). Further, in some embodiments, optical interface 200 may include additional components, such as one or more electronic integrated circuits (EICs) (e.g., EIC 606, XPU 608, memory), substrates (e.g., package substrate 602), and so forth.

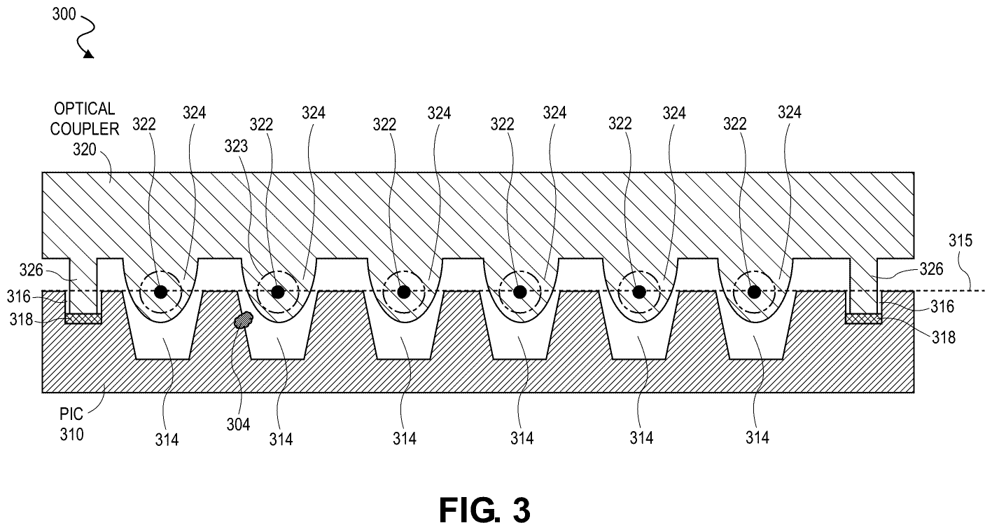

FIG. 3 illustrates an example of an optical interface 300 with locking mechanisms and alignment features having disproportionate dimensions. In the illustrated embodiment, for example, the photonic integrated circuit (PIC) 310 and the optical coupler 320 have locking mechanisms 316, 318, 326 to anchor the coupler 320 to the PIC 310, and the optical coupler 320 has alignment ridges 324 with disproportionately smaller dimensions than the alignment grooves 314 on the PIC 310 to improve process tolerance, as described below.

In the illustrated embodiment, optical interface 300 includes a PIC 310 and an optical coupler 320. Moreover, the PIC 310 and the optical coupler 320 include alignment grooves 314 and ridges 324, respectively, to align the waveguides 322 in the optical coupler 320 along the optical axis 315 of the waveguides (not shown) in the PIC 310.

As explained above, some optical interface designs have grooves and ridges on the PIC and the optical coupler with similar dimensions, but those designs are very sensitive to dimensional variation and foreign material during fabrication, which can lead to misalignment. In addition, even if the optical coupler is successfully attached to the PIC with the correct alignment, stress caused by subsequent assembly processes can cause the optical coupler to misalign along the optical axis of the PIC.

In the illustrated embodiment, however, the PIC 310 and the optical coupler 320 have locking mechanisms (e.g., locking recesses/protrusions on the mating surfaces) to anchor the optical coupler 320 to the PIC 310 and provide passive alignment, along with grooves 314 and ridges 324 with disproportionate dimensions to improve process tolerance.

For example, the PIC 310 has shallow locking recesses 316 on the surface of the die (e.g., recesses/holes in the shape of a square, circle, etc.) on opposite sides of the grooves 314, along with reflow compatible flexible polymer pads 318 at the bottom of the locking recesses 316. Moreover, the optical coupler 320 has matching locking protrusions 326 on the surface (e.g., square or round pegs) on opposite sides of the ridges 324. In this manner, the grooves 314 on the PIC 310 are positioned between the locking recesses 316, and the ridges 324 on the optical coupler 320 are positioned between the locking protrusions 326. Moreover, the locking recesses 316 and locking protrusions 326 are designed to mate.

The shapes of the locking recesses 316 and protrusions 326 may vary in different embodiments (e.g., square, round, triangular, hexagonal), but the etch process on the PIC 310 and the coupler 320 may be better for some shapes than others. In some embodiments, the recesses 316 in the PIC 310 may be larger (e.g., ˜5 μm) and deeper than the matching structure 326 on the coupler 320. Further, fiducial marks (not shown) may be placed around the recesses 316.

When mated, the locking mechanisms 316, 326 anchor the coupler 320 to the PIC 310 and passively align the waveguides 322 in the coupler 320 with the optical axis 315 of the PIC 310. Moreover, the pads 318 provide conformal passive alignment for tilt and height variation. Thus, passive alignment is collectively provided by the mated locking recesses 316 and protrusions 326, the pads 318, and the fiducials.

In this manner, the locking mechanisms increase tolerance to stress and reduce the risk of misalignment during subsequently assembly processes (e.g., when the optical interface 300 is attached to a substrate or a fiber cable is attached to the optical coupler 320), as the coupler 320 will be “anchored” into the recesses 316 on the PIC 310, which reduces the probability of movement.

Further, the grooves 314 and ridges 324 on the PIC 310 and the optical coupler 320 are designed with disproportionate dimensions to improve process tolerance. For example, the alignment ridges 324 on the optical coupler 320 are all disproportionately smaller than the corresponding alignment grooves 314 on the PIC 310. As explained above, this disparity in size between the grooves 314 and ridges 324 increases tolerance for dimensional variation and reduces the impact of foreign material 304 trapped within the grooves 314 and ridges 324 during fabrication. Further, since the locking mechanisms 316, 318, 326 provide passive alignment, the dimensions of the alignment ridges 324 can be reduced without impacting the optical properties of the coupler 320 or the waveguides 322 (as long as the ridges 324 are not shrunk smaller than the mode field diameter (MFD) 323 of the waveguides 322).

In addition, the smaller dimensions of the locking “anchors” 326 compared to the locking recesses 316, and the smaller dimensions of the alignment ridges 324 compared to the alignment grooves 314, enable the use of active force feedback during passive alignment.

It should be appreciated that optical interface 300 is merely presented as an example embodiment. In other embodiments, certain components or features may be omitted, added, rearranged, modified, or combined. In some embodiments, for example, the respective mating and alignment features on the PIC 310 and the optical coupler 320 may be reversed or modified. For example, while the PIC 310 includes alignment grooves 314 and the optical coupler 320 includes alignment ridges 324 in the illustrated embodiment, in other embodiments the PIC 310 may include alignment ridges and the optical coupler 320 may include alignment grooves. As another example, while the dimensions of the ridges 324a-f of the optical coupler 320 are reduced in the illustrated embodiment, in other embodiments the dimensions of the grooves 314a-f of the PIC 310 may be enlarged. As another example, while the PIC 310 includes locking recesses 316 and pads 318 and the optical coupler 320 includes locking protrusions 326 in the illustrated embodiment, in other embodiments the PIC 310 may include locking protrusions and the optical coupler 320 may include locking recesses and pads. As another example, the alignment grooves 314a-f, alignment ridges 324a-f, locking recesses 316, and/or locking protrusions 326 may have shapes different from those shown in the illustrated embodiment. Further, in some embodiments, the PIC 310 and the optical coupler 320 may include other mating and alignment features instead of, or in addition to, alignment grooves/ridges and locking mechanisms, such as features with different shapes or different types of features altogether. In some embodiments, the number of certain features on the PIC 310 and the optical coupler 320 may vary, such as the number of locking mechanisms, grooves, ridges, or waveguides. In addition, optical interface 300 may be modified or combined with aspects of any of the other embodiments described herein (e.g., an extended ledge/shelf, locking mechanisms, waveguide alignment features with varying dimensions, monolithic waveguide alignment features). Further, in some embodiments, optical interface 300 may include additional components, such as one or more electronic integrated circuits (EICs) (e.g., EIC 606, XPU 608, memory), substrates (e.g., package substrate 602), and so forth.

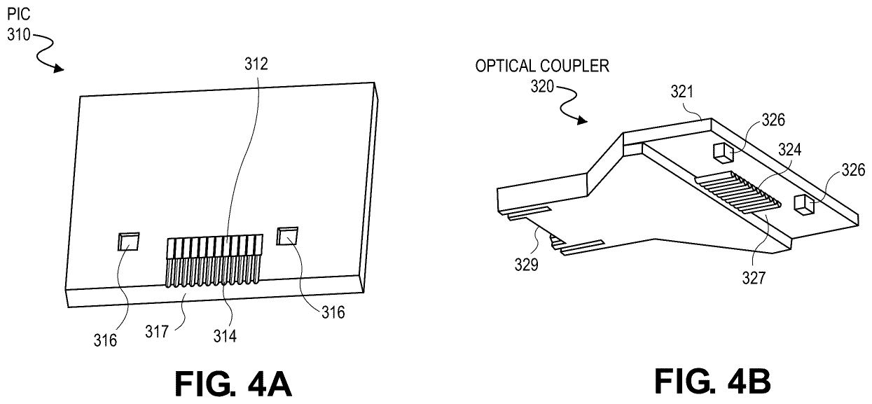

FIGS. 4A-B illustrate three-dimensional (3D) renderings of the PIC 310 and optical coupler 320 from FIG. 3. In particular, FIG. 4A illustrates the PIC 310 with locking recesses 316 on each side of the alignment grooves 314, and FIG. 4B illustrates the optical coupler 320 with locking protrusions 326 on each side of the alignment ridges 324.

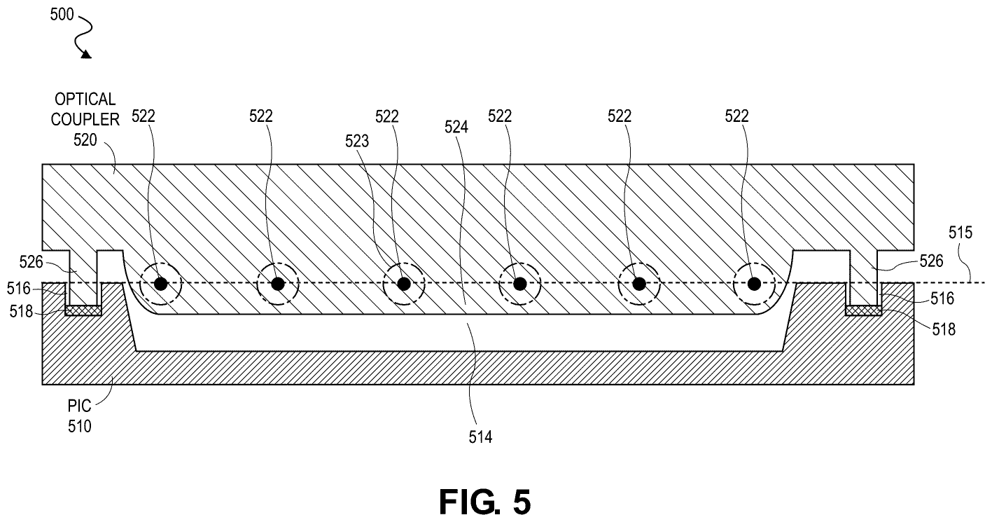

FIG. 5 illustrates an example of an optical interface 500 with locking mechanisms and monolithic alignment features. In the illustrated embodiment, for example, the optical interface 500 includes a photonic integrated circuit (PIC) 510 and an optical coupler 520 with locking mechanisms 516, 518, 526 to anchor the coupler 520 to the PIC 510, along with monolithic alignment structures 514, 524 for waveguide alignment, as described below.

In the illustrated embodiment, the locking mechanisms include recesses 516 in the PIC 510 with flexible pads 518 at the bottom, along with matching protrusions 526 on the optical coupler 520 to mate with the recesses 516 in the PIC 510. In some embodiments, these locking mechanisms 516, 518, 526 may be similar to locking mechanisms 316, 318, 326 of optical interface 300. For example, when mated, these locking mechanisms 516, 518, 526 anchor the optical coupler 520 to the PIC 510 and passively align the waveguides 522 in the coupler 520 with the optical axis 515 of the PIC 510.

Further, the PIC 510 and the optical coupler 520 also have monolithic structures 514, 524 for waveguide alignment. For example, the PIC 510 has a monolithic groove or trench 514 that abuts the waveguides (not shown) in the PIC 510, and the optical coupler 520 has a monolithic ridge or protrusion 524 with embedded waveguides 522. Moreover, these monolithic structures 514, 524 are designed to mate in order to align the waveguides 522 in the optical coupler 520 along the optical axis 515 of the waveguides in the PIC 510. In this manner, these monolithic structures 514, 524 align all waveguides 522 in the optical coupler 520 along the optical axis 515 of the PIC 510 while providing better mechanical integrity than individual grooves and ridges.

Optical interface 500 provides similar advantages as optical interface 300, along with the improved mechanical integrity of the monolithic alignment structures 514, 524 compared to individual grooves and ridges.

It should be appreciated that optical interface 500 is merely presented as an example embodiment. In other embodiments, certain components or features may be omitted, added, rearranged, modified, or combined. In some embodiments, for example, the respective mating and alignment features on the PIC 510 and the optical coupler 520 may be reversed or modified. For example, while the PIC 510 includes a monolithic alignment groove 514 and the optical coupler 520 includes a monolithic alignment ridge 524 in the illustrated embodiment, in other embodiments the PIC 510 may include a monolithic alignment ridge and the optical coupler 520 may include a monolithic alignment groove. As another example, while the PIC 510 includes locking recesses 516 and pads 518 and the optical coupler 520 includes locking protrusions 526 in the illustrated embodiment, in other embodiments the PIC 510 may include locking protrusions and the optical coupler 520 may include locking recesses and pads. As another example, the monolithic alignment groove 514, monolithic alignment ridge 524, locking recesses 516, and/or locking protrusions 526 may have shapes different from those shown in the illustrated embodiment. Further, in some embodiments, the PIC 510 and the optical coupler 520 may include other mating and alignment features instead of, or in addition to, monolithic alignment groove/ridge and locking mechanisms, such as features with different shapes or different types of features altogether. In some embodiments, the number of certain features on the PIC 510 and the optical coupler 520 may vary, such as the number of locking mechanisms, grooves, ridges, or waveguides. In addition, optical interface 500 may be modified or combined with aspects of any of the other embodiments described herein (e.g., an extended ledge/shelf, locking mechanisms, waveguide alignment features with varying dimensions, monolithic waveguide alignment features). Further, in some embodiments, optical interface 500 may include additional components, such as one or more electronic integrated circuits (EICs) (e.g., EIC 606, XPU 608, memory), substrates (e.g., package substrate 602), and so forth.

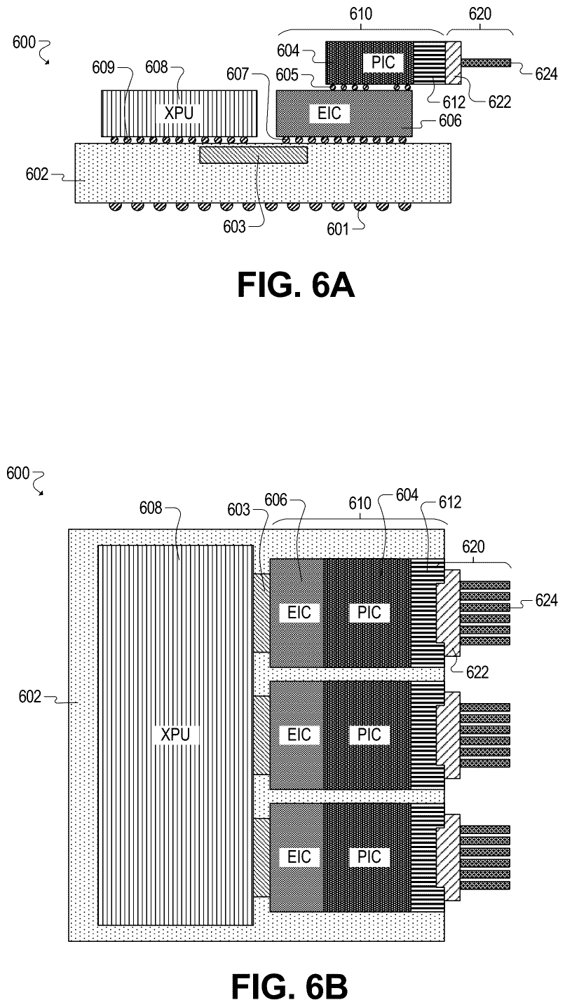

FIGS. 6A-B illustrate an example embodiment of an optical package 600 in accordance with certain embodiments. In particular, cross-section and plan views of optical package 600 are respectively shown in FIGS. 6A and 6B. In some embodiments, optical package 600 may include the photonic integrated circuit (PIC) and/or optical coupler designs described throughout this disclosure. In particular, any of the PIC and/or optical coupler designs described herein (e.g., PICs 110, 210, 310, 510, optical couplers 120, 220, 320, 520) may be used to implement PICs 604 and optical couplers 612 in optical package 600 (or any other components that are optically coupled).

In the illustrated embodiment, the optical package 600 includes an XPU 608 and multiple optical interfaces 610 on a package substrate 602, along with optical cables 620 plugged into the respective optical interfaces 610.

Each optical interface 610 includes an optical coupler 612, a photonic integrated circuit (PIC) 604, and an electronic integrated circuit (EIC) 606. The EICs 606 are attached to the top surface of the package substrate 602, the PICs 604 are attached to the top surface of corresponding EICs 606, and the optical couplers 612 are attached to the side/edge of corresponding PICs 604.

The EICs 606 are used to control the PICs 604 and may include components such as drivers, transimpedance amplifiers (TIA), carrier phase recovery (CPR), clock/data recovery (CDR), serializer/deserializer, equalizer, sampler, and so forth. The EICs 606 are electrically coupled to the package substrate 602 via conductive contacts 607 (e.g., bumps/micro-bumps), and the EICs 606 are further electrically coupled to the XPU 608 via the bridges 603 embedded in the substrate 602.

The PICs 604 are used to send and/or receive optical signals via fiber arrays 624 (e.g., on behalf of the XPU 608). Each PIC 604 includes components and circuitry for sending and receiving optical signals, such as laser diodes (LD)/modulators (LD-MOD) (e.g., for transmitting optical signals), photodiodes (PD) (e.g., for receiving optical signals), waveguides, optical couplers, collimation/refocusing lenses, reflection mirrors, and so forth. Each PIC 604 is controlled by an associated EIC 606 and is electrically coupled to the top surface of the EIC 606 via conductive contacts 605 (e.g., bumps/micro-bumps).

An optical coupler 612 is also attached to each PIC 604. The optical coupler 612, which may also be referred to as an optical interposer, is used to optically couple, or route optical signals (e.g., light) between, the PIC 604 and another optical component, such as an optical cable 620. In some embodiments, the optical coupler 612 may include an interface attached to the PIC 604, an interface to mate with an optical ferrule 622 on an optical cable 620, and waveguides to route optical signals between the respective interfaces. The optical coupler 612 may optionally include various other optical and/or electrical routing features, such as through-glass vias, reflection mirrors, and so forth.

Each optical cable 620 includes an optical ferrule 622 attached to a bundle of optical (e.g., glass) fibers 624, which may be referred to as a fiber array or fiber array unit (FAU). The optical ferrule 622 may be used to optically couple, or route optical signals between, the fiber array 624 and an optical coupler 612. In some embodiments, the optical ferrule 622 may include an interface attached to the fiber array 624 (e.g., holes in the ferrule 622 in which the fibers 624 are inserted), an interface to mate with an optical coupler 612, and waveguides to route optical signals between the respective interfaces.

In some embodiments, for example, the optical coupler 612 and the optical ferrule 622 may include complementary pluggable interfaces that are designed to mate. For example, the optical coupler 612 may include an optical socket and the optical ferrule 622 may include a corresponding optical plug designed to mate with the optical socket (or vice versa). In this manner, each PIC 604 is optically coupled to an associated fiber array 624 via the mated optical coupler 612 and optical ferrule 622.

Further, in some embodiments, the optical coupler 612 and optical ferrule 622 may include complementary mating and alignment features (e.g., mating protrusions and receptacles, pins and pin holes, grooves) to ensure they mate with each other with the requisite degree of alignment, as the waveguides in the ferrule 622 must be precisely aligned with the waveguides in the optical coupler 612. For example, when the optical ferrule 622 is plugged into to the optical coupler 612, their respective mating and alignment features engage, which causes the waveguides in the ferrule 622 to precisely align with the waveguides in the optical coupler 612. In this manner, the PIC 604 is optically coupled to the fiber array 624 via the mated optical coupler 612 and ferrule 622, which enables the PIC 604 to send and receive optical signals via the fiber array 624.

In some embodiments, the optical coupler 612 and/or optical ferrule 622 may be made of glass, and their respective features (e.g., interfaces, mating/alignment features, waveguides) may be patterned in the glass (e.g., using laser etching techniques).

The fiber array 624 may be used to send and receive optical signals to and from other components (not shown). For example, the other end of the fiber array 624 may be optically coupled to other components (not shown), such as other computing components that are part of the same device or system as optical package 600 (e.g., processors, XPUs, network interface controllers (NICs), storage, memory, I/O devices, other integrated circuits), an external device or system, a switch, another optical connector (e.g., a connector similar to optical coupler 612 and/or optical ferrule 622, a standard optical connector such as a mechanical transfer (MT) or multi-fiber push on (MPO) connector), a fiber cable, and so forth.

The XPU 608 is attached to the top surface of the package substrate 602. Moreover, the XPU 608 is electrically coupled to the package substrate 602 via conductive contacts 609 (e.g., bumps/micro-bumps), which serve as the first level interconnect (FLI) for the XPU 608. The XPU 608 is also electrically coupled to the EICs 606 via bridges 603 embedded in the substrate 602 (e.g., embedded multi-die interconnect bridges (EMIB)). In this manner, the XPU 608 can use the EICs 606 to communicate over the respective optical interfaces 610.

The XPU 608 may include any type or combination of integrated circuitry that uses the optical interfaces 610 for optical communication. For example, the XPU 608 may include any type or combination of processing units or other computing components, including, but not limited to, microcontrollers, microprocessors, processor cores, central processing units (CPUs), graphics processing units (GPUs), vision processing units (VPUs), tensor processing units (TPUs), application-specific integrated circuits (ASICs), field-programmable gate arrays (FPGAs), input/output (I/O) controllers and devices, switches, network interface controllers (NICs), persistent storage devices, and memory.

The package substrate 602 includes conductive contacts 601 (e.g., balls, pads) on the bottom surface, which serve as the second level interconnect (SLI) to a next-level component, such as a printed circuit board (e.g., a motherboard) and/or another integrated circuit package (not shown). The package substrate 602 also includes conductive traces (not shown) patterned in the substrate to provide power and input/output (I/O) to the respective components in package 600 (e.g., XPU 608, EICs 606, PICs 604).

In some embodiments, the optical package 600 may be part of an electronic device or system, such as a mobile device, a wearable device, a computer, a server, a video playback device, a video game console, a display device, a camera, or an appliance. For example, the optical package 600 and various other electronic components may be electrically coupled to a circuit board within the electronic device.

It should be appreciated that optical package 600 is merely presented as an example. In other embodiments, certain components may be omitted, added, rearranged, modified, or combined. For example, embodiments may include any number, combination, or arrangement of PICs and EICs (e.g., for higher bandwidth and/or redundancy), optical connectors, optical couplers, optical ferrules, optical interposers, fibers, bridges, XPUs or other computing components, substrates, surface cavities in the substrate, conductive contacts, conductive traces, vias, integrated circuit packages, and so forth.

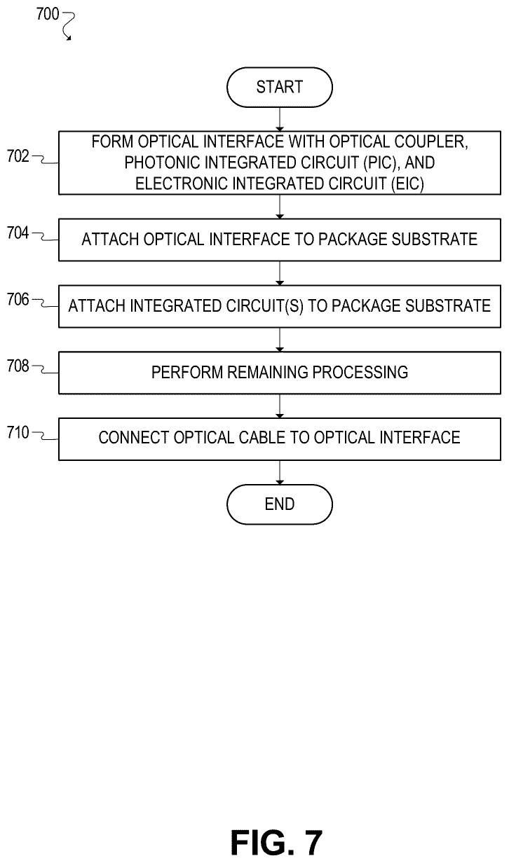

FIG. 7 illustrates a process flow 700 for forming an optical package in accordance with certain embodiments. In some embodiments, for example, the illustrated packaging process may be used to form optical packages (e.g., optical package 600) using the embodiments of optical interfaces, photonic integrated circuits (PICs), and optical couplers described herein (e.g., optical interfaces 100, 200, 300, 500, 610, PICs 110, 210, 310, 510, 604, optical couplers 120, 220, 320, 520, 612). However, it will be appreciated in light of this disclosure that the illustrated packaging process is only one example methodology for arriving at the example optical packages, optical interfaces, PICs, and optical couplers shown and described throughout this disclosure.

The process flow begins at block 702 by forming an optical interface with an optical coupler, a photonic integrated circuit (PIC), and an electronic integrated circuit (EIC). In some embodiments, for example, the respective components of the optical interface may be manufactured separately and then assembled or packaged together.

For example, the PIC and the EIC may be fabricated using panel level or wafer level semiconductor processing techniques. Moreover, the optical coupler may be fabricated by patterning various features (e.g., waveguides, interfaces, mating/alignment features) in a glass substrate (e.g., using laser-based machining/etching techniques). In some embodiments, for example, the optical coupler may be a glass-based component with multiple interfaces to mate with the PIC and another optical component (e.g., a ferrule/connector on a fiber-optic cable), waveguides extending between the respective interfaces, and various mating, alignment, and/or retention features (e.g., receptacles, protrusions, grooves, ridges, pins, pin holes, wires).

In some embodiments, the optical coupler and/or the PIC may have any of the features described herein, including, without limitation, an extended ledge, waveguide alignment features (e.g., grooves, ridges, variable dimension grooves or ridges, grooves or ridges with mismatched dimensions, monolithic groove or ridge), and/or locking features (e.g., locking recesses or protrusions).

The optical coupler, PIC, and EIC may then be assembled into an optical interface. For example, the optical coupler may be aligned and attached to the PIC (e.g., using an adhesive), and the PIC (with the attached optical coupler) may be attached and electrically coupled to the EIC, thus forming the completed optical interface.

The process flow then proceeds to block 704 to attach the optical interface to a package substrate. In some embodiments, for example, the EIC (with the PIC and optical coupler) may be attached and electrically coupled to the surface of the package substrate via conductive contacts.

In some embodiments, the package substrate may be a glass substrate or an organic substrate (e.g., made of organic compounds or materials). Further, in some embodiments, the package substrate may come with preformed conductive contacts, conductive traces/vias, embedded bridges, and so forth. Alternatively, the conductive contacts, conductive traces/vias, and embedded bridges may be formed upon receiving the package substrate. For example, conductive contacts (e.g., balls, pads) may be formed on the bottom surface of the package substrate to serve as a second level interconnect (SLI) to a next-level component, such as a printed circuit board and/or another integrated circuit package. Conductive traces may be patterned in the substrate to provide power and I/O to the respective components that will be incorporated in the package, and one or more bridges may be embedded in the package substrate to interconnect certain components.

The process flow then proceeds to block 706 to attach one or more integrated circuits (ICs) to the package substrate. In some embodiments, the ICs may be attached and/or electrically coupled to the surface of the package substrate via conductive contacts. Moreover, the ICs may be packaged or unpackaged (e.g., IC dies and/or IC packages). Further, the ICs may include any type or combination of circuitry, including, without limitation, processing circuitry, memory circuitry, storage circuitry, and/or communication circuitry. In some embodiments, for example, the ICs may include, without limitation, a microcontroller, a microprocessor, a central processing unit (CPU), a graphics processing unit (GPU), a vision processing unit (VPU), a tensor processing unit (TPU), an application-specific integrated circuit (ASIC), a field-programmable gate array (FPGA), a switch, a network interface controller (NIC), a memory device (e.g., memory, memory controller), and/or a persistent storage device (e.g., hard disk drive (HDD), solid state drive (SSD)), among other examples.

The process flow then proceeds to block 708 to perform any remaining processing. In some embodiments, for example, the remaining empty areas in the package may be filled with a dielectric material (e.g., an epoxy).

The process flow then proceeds to block 710 to connect an optical cable to the optical interface. For example, the optical cable may include an optical connector, or ferrule, attached to a bundle of optical (e.g., glass) fibers. Further, the ferrule on the optical cable may be plugged into the optical coupler on the PIC to optically couple the fibers to the PIC. For example, when the ferrule is plugged into the optical coupler, the fibers in the ferrule align with the waveguides in the optical coupler, thus optically coupling the fibers to the PIC.

At this point, the process flow may be complete. In some embodiments, however, the process flow may restart and/or certain blocks may be repeated. For example, in some embodiments, the process flow may restart at block 702 to continue forming optical packages.

### Example Integrated Circuit Embodiments

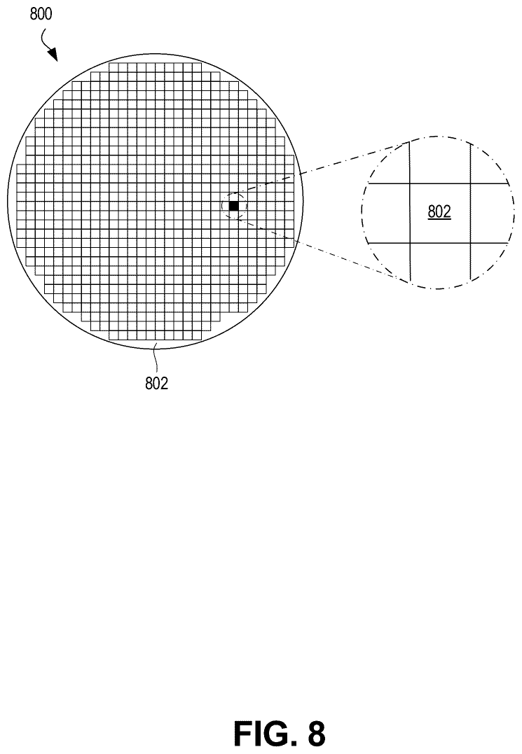

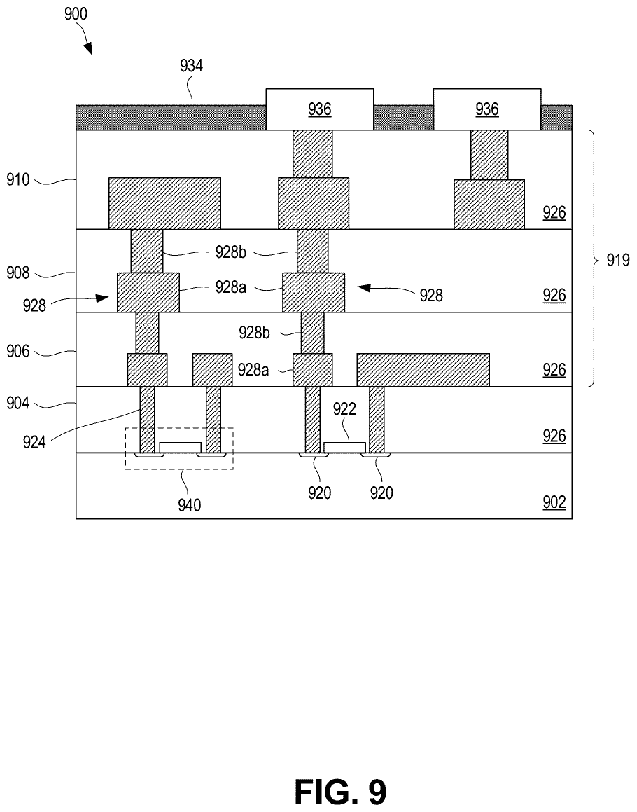

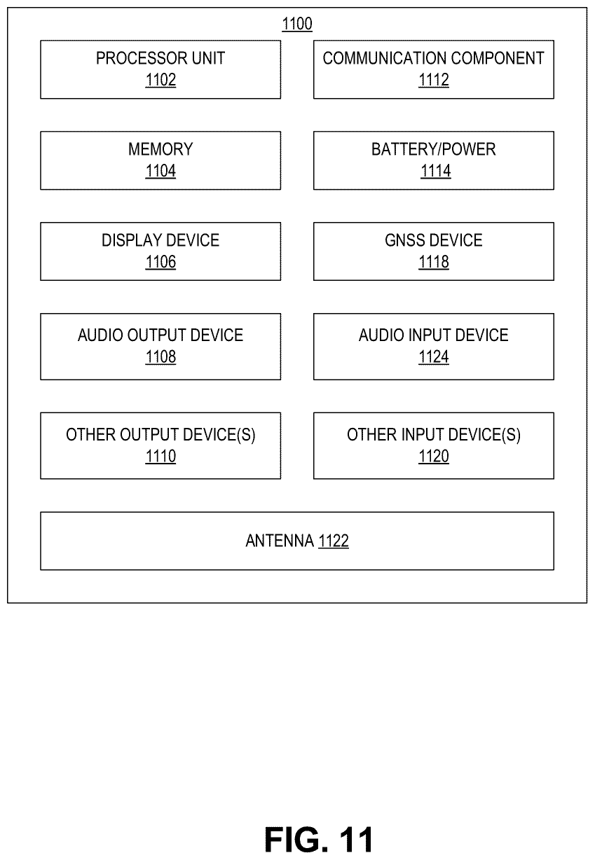

FIG. 8 is a top view of a wafer 800 and dies 802 that may be included in any of the embodiments disclosed herein. The wafer 800 may be composed of semiconductor material and may include one or more dies 802 having integrated circuit structures formed on a surface of the wafer 800. The individual dies 802 may be a repeating unit of an integrated circuit product that includes any suitable integrated circuit. After the fabrication of the semiconductor product is complete, the wafer 800 may undergo a singulation process in which the dies 802 are separated from one another to provide discrete “chips” of the integrated circuit product. The die 802 may be any of the dies disclosed herein. The die 802 may include one or more transistors (e.g., some of the transistors 940 of FIG. 9, discussed below), supporting circuitry to route electrical signals to the transistors, passive components (e.g., signal traces, resistors, capacitors, or inductors), and/or any other integrated circuit components. In some embodiments, the wafer 800 or the die 802 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 802. For example, a memory array formed by multiple memory devices may be formed on a same die 802 as a processor unit (e.g., the processor unit 1102 of FIG. 11) or other logic that is configured to store information in the memory devices or execute instructions stored in the memory array. Various ones of the microelectronic assemblies disclosed herein may be manufactured using a die-to-wafer assembly technique in which some dies are attached to a wafer 800 that include others of the dies, and the wafer 800 is subsequently singulated.

FIG. 9 is a cross-sectional side view of an integrated circuit device 900 that may be included in any of the embodiments disclosed herein (e.g., in any of the dies, such as photonic integrated circuits (PICs) 110, 210, 310, 510, 604, electronic integrated circuits (EICs) 606, XPUs 608). One or more of the integrated circuit devices 900 may be included in one or more dies 802 (FIG. 8). The integrated circuit device 900 may be formed on a die substrate 902 (e.g., the wafer 800 of FIG. 8) and may be included in a die (e.g., the die 802 of FIG. 8). The die substrate 902 may be a semiconductor substrate composed of semiconductor material systems including, for example, n-type or p-type materials systems (or a combination of both). The die substrate 902 may include, for example, a crystalline substrate formed using a bulk silicon or a silicon-on-insulator (SOI) substructure. In some embodiments, the die substrate 902 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 902. Although a few examples of materials from which the die substrate 902 may be formed are described here, any material that may serve as a foundation for an integrated circuit device 900 may be used. The die substrate 902 may be part of a singulated die (e.g., the dies 802 of FIG. 8) or a wafer (e.g., the wafer 800 of FIG. 8).

The integrated circuit device 900 may include one or more device layers 904 disposed on the die substrate 902. The device layer 904 may include features of one or more transistors 940 (e.g., metal oxide semiconductor field-effect transistors (MOSFETs)) formed on the die substrate 902. The transistors 940 may include, for example, one or more source and/or drain (S/D) regions 920, a gate 922 to control current flow between the S/D regions 920, and one or more S/D contacts 924 to route electrical signals to/from the S/D regions 920. The transistors 940 may include additional features not depicted for the sake of clarity, such as device isolation regions, gate contacts, and the like. The transistors 940 are not limited to the type and configuration depicted in FIG. 9 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

Returning to FIG. 9, a transistor 940 may include a gate 922 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 940 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 940 along the source-channel-drain direction, the gate electrode may consist of a U-shaped structure that includes a bottom portion substantially parallel to the surface of the die substrate 902 and two sidewall portions that are substantially perpendicular to the top surface of the die substrate 902. In other embodiments, at least one of the metal layers that form the gate electrode may simply be a planar layer that is substantially parallel to the top surface of the die substrate 902 and does not include sidewall portions substantially perpendicular to the top surface of the die substrate 902. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 920 may be formed within the die substrate 902 adjacent to the gate 922 of individual transistors 940. The S/D regions 920 may be formed using an implantation/diffusion process or an etching/deposition process, for example. In the former process, dopants such as boron, aluminum, antimony, phosphorous, or arsenic may be ion-implanted into the die substrate 902 to form the S/D regions 920. An annealing process that activates the dopants and causes them to diffuse farther into the die substrate 902 may follow the ion-implantation process. In the latter process, the die substrate 902 may first be etched to form recesses at the locations of the S/D regions 920. An epitaxial deposition process may then be carried out to fill the recesses with material that is used to fabricate the S/D regions 920. In some implementations, the S/D regions 920 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 920 may be formed using one or more alternate semiconductor materials such as germanium or a group III-V material or alloy. In further embodiments, one or more layers of metal and/or metal alloys may be used to form the S/D regions 920.

Electrical signals, such as power and/or input/output (I/O) signals, may be routed to and/or from the devices (e.g., transistors 940) of the device layer 904 through one or more interconnect layers disposed on the device layer 904 (illustrated in FIG. 9 as interconnect layers 906-910). For example, electrically conductive features of the device layer 904 (e.g., the gate 922 and the S/D contacts 924) may be electrically coupled with the interconnect structures 928 of the interconnect layers 906-910. The one or more interconnect layers 906-910 may form a metallization stack (also referred to as an “ILD stack”) 919 of the integrated circuit device 900.

The interconnect structures 928 may be arranged within the interconnect layers 906-910 to route electrical signals according to a wide variety of designs; in particular, the arrangement is not limited to the particular configuration of interconnect structures 928 depicted in FIG. 9. Although a particular number of interconnect layers 906-910 is depicted in FIG. 9, embodiments of the present disclosure include integrated circuit devices having more or fewer interconnect layers than depicted.

In some embodiments, the interconnect structures 928 may include lines 928a and/or vias 928b filled with an electrically conductive material such as a metal. The lines 928a may be arranged to route electrical signals in a direction of a plane that is substantially parallel with a surface of the die substrate 902 upon which the device layer 904 is formed. For example, the lines 928a may route electrical signals in a direction in and out of the page and/or in a direction across the page from the perspective of FIG. 9. The vias 928b may be arranged to route electrical signals in a direction of a plane that is substantially perpendicular to the surface of the die substrate 902 upon which the device layer 904 is formed. In some embodiments, the vias 928b may electrically couple lines 928a of different interconnect layers 906-910 together.

The interconnect layers 906-910 may include a dielectric material 926 disposed between the interconnect structures 928, as shown in FIG. 9. In some embodiments, dielectric material 926 disposed between the interconnect structures 928 in different ones of the interconnect layers 906-910 may have different compositions; in other embodiments, the composition of the dielectric material 926 between different interconnect layers 906-910 may be the same. The device layer 904 may include a dielectric material 926 disposed between the transistors 940 and a bottom layer of the metallization stack as well. The dielectric material 926 included in the device layer 904 may have a different composition than the dielectric material 926 included in the interconnect layers 906-910; in other embodiments, the composition of the dielectric material 926 in the device layer 904 may be the same as a dielectric material 926 included in any one of the interconnect layers 906-910.

A first interconnect layer 906 (referred to as Metal 1 or “M1”) may be formed directly on the device layer 904. In some embodiments, the first interconnect layer 906 may include lines 928a and/or vias 928b, as shown. The lines 928a of the first interconnect layer 906 may be coupled with contacts (e.g., the S/D contacts 924) of the device layer 904. The vias 928b of the first interconnect layer 906 may be coupled with the lines 928a of a second interconnect layer 908.

The second interconnect layer 908 (referred to as Metal 2 or “M2”) may be formed directly on the first interconnect layer 906. In some embodiments, the second interconnect layer 908 may include via 928b to couple the lines 928 of the second interconnect layer 908 with the lines 928a of a third interconnect layer 910. Although the lines 928a and the vias 928b are structurally delineated with a line within individual interconnect layers for the sake of clarity, the lines 928a and the vias 928b may be structurally and/or materially contiguous (e.g., simultaneously filled during a dual-damascene process) in some embodiments.

The third interconnect layer 910 (referred to as Metal 3 or “M3”) (and additional interconnect layers, as desired) may be formed in succession on the second interconnect layer 908 according to similar techniques and configurations described in connection with the second interconnect layer 908 or the first interconnect layer 906. In some embodiments, the interconnect layers that are “higher up” in the metallization stack 919 in the integrated circuit device 900 (i.e., farther away from the device layer 904) may be thicker that the interconnect layers that are lower in the metallization stack 919, with lines 928a and vias 928b in the higher interconnect layers being thicker than those in the lower interconnect layers.

The integrated circuit device 900 may include a solder resist material 934 (e.g., polyimide or similar material) and one or more conductive contacts 936 formed on the interconnect layers 906-910. In FIG. 9, the conductive contacts 936 are illustrated as taking the form of bond pads. The conductive contacts 936 may be electrically coupled with the interconnect structures 928 and configured to route the electrical signals of the transistor(s) 940 to external devices. For example, solder bonds may be formed on the one or more conductive contacts 936 to mechanically and/or electrically couple an integrated circuit die including the integrated circuit device 900 with another component (e.g., a printed circuit board). The integrated circuit device 900 may include additional or alternate structures to route the electrical signals from the interconnect layers 906-910; for example, the conductive contacts 936 may include other analogous features (e.g., posts) that route the electrical signals to external components. The conductive contacts 936 may serve as any of the conductive contacts described throughout this disclosure.

In some embodiments in which the integrated circuit device 900 is a double-sided die, the integrated circuit device 900 may include another metallization stack (not shown) on the opposite side of the device layer(s) 904. This metallization stack may include multiple interconnect layers as discussed above with reference to the interconnect layers 906-910, to provide conductive pathways (e.g., including conductive lines and vias) between the device layer(s) 904 and additional conductive contacts (not shown) on the opposite side of the integrated circuit device 900 from the conductive contacts 936. These additional conductive contacts may serve as any of the conductive contacts described throughout this disclosure.

In other embodiments in which the integrated circuit device 900 is a double-sided die, the integrated circuit device 900 may include one or more through silicon vias (TSVs) through the die substrate 902; these TSVs may make contact with the device layer(s) 904, and may provide conductive pathways between the device layer(s) 904 and additional conductive contacts (not shown) on the opposite side of the integrated circuit device 900 from the conductive contacts 936. These additional conductive contacts may serve as any of the conductive contacts described throughout this disclosure. In some embodiments, TSVs extending through the substrate can be used for routing power and ground signals from conductive contacts on the opposite side of the integrated circuit device 900 from the conductive contacts 936 to the transistors 940 and any other components integrated into the die 900, and the metallization stack 919 can be used to route I/O signals from the conductive contacts 936 to transistors 940 and any other components integrated into the die 900.

Multiple integrated circuit devices 900 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

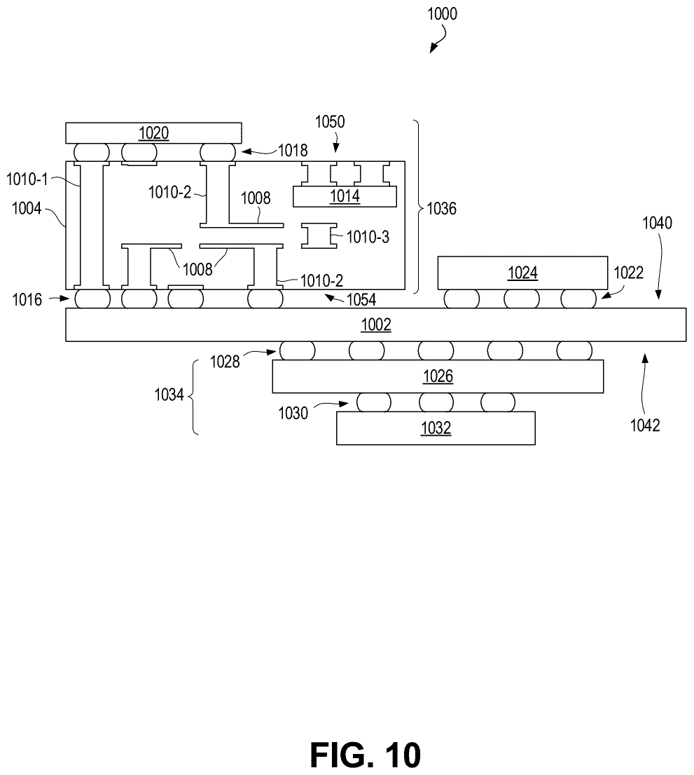

FIG. 10 is a cross-sectional side view of an integrated circuit device assembly 1000 that may include any of the embodiments disclosed herein (e.g., optical interfaces 100, 200, 300, 500, 610, photonic integrated circuits (PICs) 110, 210, 310, 510, 604, optical couplers 120, 220, 320, 520, 612, optical packages 600). In some embodiments, the integrated circuit device assembly 1000 may be a microelectronic assembly. The integrated circuit device assembly 1000 includes a number of components disposed on a circuit board 1002 (which may be a motherboard, system board, mainboard, etc.). The integrated circuit device assembly 1000 includes components disposed on a first face 1040 of the circuit board 1002 and an opposing second face 1042 of the circuit board 1002; generally, components may be disposed on one or both faces 1040 and 1042. Any of the integrated circuit components discussed below with reference to the integrated circuit device assembly 1000 may take the form of any suitable ones of the embodiments of the microelectronic assemblies disclosed herein.

In some embodiments, the circuit board 1002 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1002. In other embodiments, the circuit board 1002 may be a non-PCB substrate. The integrated circuit device assembly 1000 illustrated in FIG. 10 includes a package-on-interposer structure 1036 coupled to the first face 1040 of the circuit board 1002 by coupling components 1016. The coupling components 1016 may electrically and mechanically couple the package-on-interposer structure 1036 to the circuit board 1002, and may include solder balls (as shown in FIG. 10), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1016 may serve as the coupling components illustrated or described for any of the substrate assembly or substrate assembly components described herein, as appropriate.

The package-on-interposer structure 1036 may include an integrated circuit component 1020 coupled to an interposer 1004 by coupling components 1018. The coupling components 1018 may take any suitable form for the application, such as the forms discussed above with reference to the coupling components 1016. Although a single integrated circuit component 1020 is shown in FIG. 10, multiple integrated circuit components may be coupled to the interposer 1004; indeed, additional interposers may be coupled to the interposer 1004. The interposer 1004 may provide an intervening substrate used to bridge the circuit board 1002 and the integrated circuit component 1020.

The integrated circuit component 1020 may be a packaged or unpacked integrated circuit product that includes one or more integrated circuit dies (e.g., the die 802 of FIG. 8, the integrated circuit device 900 of FIG. 9) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1020, a single monolithic integrated circuit die comprises solder bumps attached to contacts on the die. The solder bumps allow the die to be directly attached to the interposer 1004. The integrated circuit component 1020 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1020 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1020 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1020 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1004 may spread connections to a wider pitch or reroute a connection to a different connection. For example, the interposer 1004 may couple the integrated circuit component 1020 to a set of ball grid array (BGA) conductive contacts of the coupling components 1016 for coupling to the circuit board 1002. In the embodiment illustrated in FIG. 10, the integrated circuit component 1020 and the circuit board 1002 are attached to opposing sides of the interposer 1004; in other embodiments, the integrated circuit component 1020 and the circuit board 1002 may be attached to a same side of the interposer 1004. In some embodiments, three or more components may be interconnected by way of the interposer 1004.

In some embodiments, the interposer 1004 may be formed as a PCB, including multiple metal layers separated from one another by layers of dielectric material and interconnected by electrically conductive vias. In some embodiments, the interposer 1004 may be formed of an epoxy resin, a fiberglass-reinforced epoxy resin, an epoxy resin with inorganic fillers, a ceramic material, or a polymer material such as polyimide. In some embodiments, the interposer 1004 may be formed of alternate rigid or flexible materials that may include the same materials described above for use in a semiconductor substrate, such as silicon, germanium, and other group III-V and group IV materials. The interposer 1004 may include metal interconnects 1008 and vias 1010, including but not limited to through hole vias 1010-1 (that extend from a first face 1050 of the interposer 1004 to a second face 1054 of the interposer 1004), blind vias 1010-2 (that extend from the first or second faces 1050 or 1054 of the interposer 1004 to an internal metal layer), and buried vias 1010-3 (that connect internal metal layers).

In some embodiments, the interposer 1004 can comprise a silicon interposer. Through silicon vias (TSV) extending through the silicon interposer can connect connections on a first face of a silicon interposer to an opposing second face of the silicon interposer. In some embodiments, an interposer 1004 comprising a silicon interposer can further comprise one or more routing layers to route connections on a first face of the interposer 1004 to an opposing second face of the interposer 1004.

The interposer 1004 may further include embedded devices 1014, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1004. The package-on-interposer structure 1036 may take the form of any of the package-on-interposer structures known in the art. In embodiments where the interposer is a non-printed circuit board

The integrated circuit device assembly 1000 may include an integrated circuit component 1024 coupled to the first face 1040 of the circuit board 1002 by coupling components 1022. The coupling components 1022 may take the form of any of the embodiments discussed above with reference to the coupling components 1016, and the integrated circuit component 1024 may take the form of any of the embodiments discussed above with reference to the integrated circuit component 1020.

The integrated circuit device assembly 1000 illustrated in FIG. 10 includes a package-on-package structure 1034 coupled to the second face 1042 of the circuit board 1002 by coupling components 1028. The package-on-package structure 1034 may include an integrated circuit component 1026 and an integrated circuit component 1032 coupled together by coupling components 1030 such that the integrated circuit component 1026 is disposed between the circuit board 1002 and the integrated circuit component 1032. The coupling components 1028 and 1030 may take the form of any of the embodiments of the coupling components 1016 discussed above, and the integrated circuit components 1026 and 1032 may take the form of any of the embodiments of the integrated circuit component 1020 discussed above. The package-on-package structure 1034 may be configured in accordance with any of the package-on-package structures known in the art.

FIG. 11 is a block diagram of an example electronic device 1100 that may include one or more of the embodiments disclosed herein. For example, any suitable ones of the components of the electronic device 1100 may include one or more of the optical components (e.g., optical interfaces 100, 200, 300, 500, 610, photonic integrated circuits (PICs) 110, 210, 310, 510, 604, optical couplers 120, 220, 320, 520, 612, optical packages 600), integrated circuit device assemblies 1000, integrated circuit components 1020, integrated circuit devices 900, or integrated circuit dies 802 disclosed herein. In some embodiments, for example, the electronic device 1100 and/or its respective components (e.g., processor units 1102, input/output (I/O) devices 1110, 1120, communication components 1112, memory 1104) may include an optical interface for optical communication according to any of the embodiments described herein. A number of components are illustrated in FIG. 11 as included in the electronic device 1100, but any one or more of these components may be omitted or duplicated, as suitable for the application. In some embodiments, some or all of the components included in the electronic device 1100 may be attached to one or more motherboards mainboards, or system boards. In some embodiments, one or more of these components are fabricated onto a single system-on-a-chip (SoC) die.

Additionally, in various embodiments, the electronic device 1100 may not include one or more of the components illustrated in FIG. 11, but the electronic device 1100 may include interface circuitry for coupling to the one or more components. For example, the electronic device 1100 may not include a display device 1106, but may include display device interface circuitry (e.g., a connector and driver circuitry) to which a display device 1106 may be coupled. In another set of examples, the electronic device 1100 may not include an audio input device 1124 or an audio output device 1108, but may include audio input or output device interface circuitry (e.g., connectors and supporting circuitry) to which an audio input device 1124 or audio output device 1108 may be coupled.

The electronic device 1100 may include one or more processor units 1102 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1102 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electronic device 1100 may include a memory 1104, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1104 may include memory that is located on the same integrated circuit die as the processor unit 1102. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electronic device 1100 can comprise one or more processor units 1102 that are heterogeneous or asymmetric to another processor unit 1102 in the electronic device 1100. There can be a variety of differences between the processing units 1102 in a system in terms of a spectrum of metrics of merit including architectural, microarchitectural, thermal, power consumption characteristics, and the like. These differences can effectively manifest themselves as asymmetry and heterogeneity among the processor units 1102 in the electronic device 1100.

In some embodiments, the electronic device 1100 may include a communication component 1112 (e.g., one or more communication components). For example, the communication component 1112 can manage wireless communications for the transfer of data to and from the electronic device 1100. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1112 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1112 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1112 may operate in accordance with other wireless protocols in other embodiments. The electronic device 1100 may include an antenna 1122 to facilitate wireless communications and/or to receive other wireless communications (such as AM or FM radio transmissions).

In some embodiments, the communication component 1112 may manage wired communications, such as electrical, optical, or any other suitable communication protocols (e.g., IEEE 802.3 Ethernet standards). As noted above, the communication component 1112 may include multiple communication components. For instance, a first communication component 1112 may be dedicated to shorter-range wireless communications such as Wi-Fi or Bluetooth, and a second communication component 1112 may be dedicated to longer-range wireless communications such as global positioning system (GPS), EDGE, GPRS, CDMA, WiMAX, LTE, EV-DO, or others. In some embodiments, a first communication component 1112 may be dedicated to wireless communications, and a second communication component 1112 may be dedicated to wired communications.

The electronic device 1100 may include battery/power circuitry 1114. The battery/power circuitry 1114 may include one or more energy storage devices (e.g., batteries or capacitors) and/or circuitry for coupling components of the electronic device 1100 to an energy source separate from the electronic device 1100 (e.g., AC line power).

The electronic device 1100 may include a display device 1106 (or corresponding interface circuitry, as discussed above). The display device 1106 may include one or more embedded or wired or wirelessly connected external visual indicators, such as a heads-up display, a computer monitor, a projector, a touchscreen display, a liquid crystal display (LCD), a light-emitting diode display, or a flat panel display.

The electronic device 1100 may include an audio output device 1108 (or corresponding interface circuitry, as discussed above). The audio output device 1108 may include any embedded or wired or wirelessly connected external device that generates an audible indicator, such speakers, headsets, or earbuds.

The electronic device 1100 may include an audio input device 1124 (or corresponding interface circuitry, as discussed above). The audio input device 1124 may include any embedded or wired or wirelessly connected device that generates a signal representative of a sound, such as microphones, microphone arrays, or digital instruments (e.g., instruments having a musical instrument digital interface (MIDI) output). The electronic device 1100 may include a Global Navigation Satellite System (GNSS) device 1118 (or corresponding interface circuitry, as discussed above), such as a Global Positioning System (GPS) device. The GNSS device 1118 may be in communication with a satellite-based system and may determine a geolocation of the electronic device 1100 based on information received from one or more GNSS satellites, as known in the art.

The electronic device 1100 may include other output device(s) 1110 (or corresponding interface circuitry, as discussed above). Examples of the other output device(s) 1110 may include an audio codec, a video codec, a printer, a wired or wireless transmitter for providing information to other devices, or an additional storage device.

The electronic device 1100 may include other input device(s) 1120 (or corresponding interface circuitry, as discussed above). Examples of the other input device(s) 1120 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electronic device 1100 may have any desired form factor, such as a hand-held or mobile electronic device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electronic device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electronic device or an embedded computing system (e.g., computing systems that are part of a vehicle, smart home appliance, consumer electronics product or equipment, manufacturing equipment). In some embodiments, the electronic device 1100 may be any other electrical or electronic device that processes data. In some embodiments, the electronic device 1100 may comprise multiple discrete physical components. Given the range of devices that the electronic device 1100 can be manifested as in various embodiments, in some embodiments, the electronic device 1100 can be referred to as a computing device or a computing system.

### Examples

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes an integrated circuit package, comprising: a photonic integrated circuit (PIC) to send or receive optical signals, wherein the PIC comprises a first interface; and an optical coupler to optically couple the PIC to one or more optical fibers, wherein the optical coupler comprises a second interface coupled to the first interface on the PIC; wherein one of the first interface or the second interface comprises: at least two recesses; and one or more grooves positioned between the recesses; wherein the other of the first interface or the second interface comprises: at least two protrusions, wherein the protrusions are mated with the recesses; and one or more ridges positioned between the protrusions, wherein the one or more ridges are mated with the one or more grooves.

Example 2 includes the integrated circuit package of Example 1, wherein the one or more grooves and the one or more ridges are mated to align waveguides in the PIC with waveguides in the optical coupler.

Example 3 includes the integrated circuit package of Example 2, wherein: the first interface comprises the recesses and the one or more grooves; and the second interface comprises the protrusions and the one or more ridges.

Example 4 includes the integrated circuit package of Example 3, wherein the second interface further comprises a ledge, wherein the ledge comprises the protrusions and the one or more ridges, and wherein the ledge extends beyond the one or more ridges.

Example 5 includes the integrated circuit package of any of Examples 3-4, wherein: the waveguides in the PIC extend to the one or more grooves; and the waveguides in the optical coupler extend through the one or more ridges.

Example 6 includes the integrated circuit package of any of Examples 1-5, wherein: the one or more grooves comprise a monolithic groove; and the one or more ridges comprise a monolithic ridge.

Example 7 includes the integrated circuit package of any of Examples 1-5, wherein: the one or more grooves comprise a plurality of grooves; and the one or more ridges comprise a plurality of ridges.

Example 8 includes the integrated circuit package of Example 7, wherein: the plurality of grooves vary in size; or the plurality of ridges vary in size.

Example 9 includes the integrated circuit package of any of Examples 1-8, further comprising polymer pads within the respective recesses.

Example 10 includes the integrated circuit package of any of Examples 1-9, wherein the one or more optical fibers are comprised in an optical cable, wherein the optical cable is configured to mate with the optical coupler.

Example 11 includes the integrated circuit package of any of Examples 1-10, further comprising an integrated circuit die, wherein the integrated circuit die is to communicate optically via the PIC, and wherein the integrated circuit die comprises processing circuitry, memory circuitry, storage circuitry, or communication circuitry.

Example 12 includes a system, comprising: a circuit board; and an integrated circuit package electrically coupled to the circuit board, wherein the integrated circuit package comprises an optical interface, wherein the optical interface comprises: a photonic integrated circuit (PIC) to send or receive optical signals, wherein the PIC comprises at least two recesses and one or more grooves positioned between the recesses; and an optical coupler to optically couple the PIC to one or more optical fibers, wherein the optical coupler comprises at least two protrusions and one or more ridges positioned between the protrusions, wherein the protrusions are mated with the recesses on the PIC, and wherein the one or more ridges are mated with the one or more grooves on the PIC.

Example 13 includes the system of Example 12, wherein the one or more ridges are mated with the one or more grooves to align waveguides in the optical coupler with waveguides in the PIC, wherein the waveguides in the optical coupler extend through the one or more ridges, and wherein the waveguides in the PIC extend to the one or more grooves.

Example 14 includes the system of any of Examples 12-13, wherein: the one or more grooves comprise a monolithic groove; and the one or more ridges comprise a monolithic ridge.

Example 15 includes the system of any of Examples 12-13, wherein: the one or more grooves comprise a plurality of grooves; and the one or more ridges comprise a plurality of ridges.

Example 16 includes the system of any of Examples 12-15, wherein the PIC further comprises polymer pads within the respective recesses.

Example 17 includes the system of any of Examples 12-16, wherein the integrated circuit package further comprises an integrated circuit die, wherein the integrated circuit die is to communicate optically via the optical interface, and wherein the integrated circuit die comprises processing circuitry, memory circuitry, storage circuitry, or communication circuitry.

Example 18 includes the system of any of Examples 12-17, wherein the system is comprised in a mobile device, a wearable device, a computer, a server, a video playback device, a video game console, a display device, a camera, or an appliance.

Example 19 includes a device, comprising: a photonic integrated circuit (PIC), wherein the PIC comprises: at least two recesses on a surface of the PIC; and one or more grooves on the surface of the PIC, wherein the one or more grooves are positioned between the recesses.

Example 20 includes the device of Example 19, further comprising an electronic integrated circuit (EIC) conductively coupled to the PIC.

Example 21 includes a device, comprising: a plurality of optical waveguides; one or more grooves on a surface of the device, wherein the optical waveguides extend to the one or more grooves; and at least two recesses on the surface of the device, wherein the recesses are positioned on opposite sides of the one or more grooves.

Example 22 includes the device of Example 21, further comprising an electronic integrated circuit (EIC) conductively coupled to the device.

Example 23 includes a photonic integrated circuit, comprising: an interface to mate with an optical coupler, wherein the interface comprises: at least two recesses, wherein the recesses are to mate with corresponding protrusions on the optical coupler; and one or more grooves positioned between the recesses, wherein the one or more grooves are to mate with one or more corresponding ridges on the optical coupler; and a plurality of waveguides extending to the one or more grooves.

Example 24 includes an optical coupler, comprising: a first interface to mate with a photonic integrated circuit (PIC), wherein the first interface comprises: at least two protrusions, wherein the protrusions are to mate with corresponding recesses on the PIC; and one or more ridges positioned between the protrusions, wherein the one or more ridges are to mate with one or more corresponding grooves on the PIC; a second interface to mate with an optical cable; and a plurality of waveguides extending from the first interface to the second interface, wherein when the first interface is mated with the PIC and the second interface is mated with the optical cable, the PIC and the optical cable are optically coupled via the plurality of waveguides.

Example 25 includes a method, comprising: forming an optical interface, wherein the optical interface comprises: an optical coupler, wherein the optical coupler comprises at least two protrusions and one or more ridges positioned between the protrusions; and a photonic integrated circuit (PIC), wherein the PIC comprises at least two recesses and one or more grooves positioned between the recesses, wherein the recesses are to mate with the protrusions on the optical coupler, and wherein the one or more grooves are to mate with the one or more ridges on the optical coupler; attaching the optical interface to a package substrate; and attaching an integrated circuit die to the package substrate.

Example 26 includes the method of Example 25, wherein the optical interface further comprises an electronic integrated circuit (EIC) to control the PIC.

Example 27 includes the method of Example 26, wherein forming the optical interface comprises: attaching the optical coupler to the PIC; and attaching the PIC to the EIC.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. Further, it should be understood that the various embodiments shown in the figures are illustrative representations and are not necessarily drawn to scale.

Moreover, the illustrations and/or descriptions of various embodiments may be simplified or approximated for ease of understanding, and as a result, they may not necessarily reflect the level of precision nor variation that may be present in actual embodiments. For example, while some figures generally indicate straight lines, right angles, and smooth surfaces, actual implementations of the disclosed embodiments may have less than perfect straight lines and right angles, and some features may have surface topography or otherwise be non-smooth, given real-world limitations of fabrication processes. Similarly, illustrations and/or descriptions of how components are arranged may be simplified or approximated for ease of understanding and may vary by some margin of error in actual embodiments (e.g., due to fabrication processes, etc.).

Unless otherwise specified, the use of the ordinal adjectives “first,” “second,” and “third,” etc., to describe a common object, merely indicate that different instances of like objects to which are being referred and are not intended to imply that the objects so described must be in a given sequence, either temporally, spatially, in ranking or in any other manner.

The terms “substantially,” “close,” “approximately,” “near,” and “about,” generally refer to being within +/−10% of a target value (unless otherwise specified). Similarly, terms describing spatial relationships, such as “perpendicular,” “orthogonal,” or “coplanar,” may refer to being substantially within the described spatial relationships (e.g., within +/−10 degrees of orthogonality).

Certain terminology may also be used in the foregoing description for the purpose of reference only, and thus are not intended to be limiting. For example, terms such as “upper,” “lower,” “above,” “below,” “bottom,” and “top” refer to directions in the drawings to which reference is made. Terms such as “front,” “back,” “rear,” and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

The terms “over”, “between”, “adjacent”, “to”, and “on” as used herein may refer to a relative position of one layer or component with respect to other layers or components. For example, one layer “over” or “on” another layer, “adjacent” to another layer, or bonded “to” another layer may be directly in contact with the other layer or may have one or more intervening layers. One layer “between” layers may be directly in contact with the layers or may have one or more intervening layers.

The meaning of “a,” “an,” and “the” include plural references. The meaning of “in” includes “in” and “on.”

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

Views labeled “cross-sectional”, “profile” and “plan” correspond to orthogonal planes within a cartesian coordinate system. Thus, cross-sectional and profile views are taken in the x-z plane, and plan views are taken in the x-y plane. Typically, profile views in the x-z plane are cross-sectional views. Where appropriate, drawings are labeled with axes to indicate the orientation of the figure.

The term “package” generally refers to a self-contained carrier of one or more dice, where the dice are attached to the package substrate, and may be encapsulated for protection, with integrated or wire-bonded interconnects between the dice and leads, pins or bumps located on the external portions of the package substrate. The package may contain a single die, or multiple dice, providing a specific function. The package is usually mounted on a printed circuit board for interconnection with other packaged integrated circuits and discrete components, forming a larger circuit.

The term “cored” generally refers to a substrate of an integrated circuit package built upon a board, card or wafer comprising a non-flexible stiff material. Typically, a small printed circuit board is used as a core, upon which integrated circuit device and discrete passive components may be soldered. Typically, the core has vias extending from one side to the other, allowing circuitry on one side of the core to be coupled directly to circuitry on the opposite side of the core. The core may also serve as a platform for building up layers of conductors and dielectric materials.

The term “coreless” generally refers to a substrate of an integrated circuit package having no core. The lack of a core allows for higher-density package architectures, as the through-vias have relatively large dimensions and pitch compared to high-density interconnects.

The term “land side”, if used herein, generally refers to the side of the substrate of the integrated circuit package closest to the plane of attachment to a printed circuit board, motherboard, or other package. This is in contrast to the term “die side”, which is the side of the substrate of the integrated circuit package to which the die or dice are attached.

The term “dielectric” generally refers to any number of non-electrically conductive materials that make up the structure of a package substrate. For purposes of this disclosure, dielectric material may be incorporated into an integrated circuit package as layers of laminate film or as a resin molded over integrated circuit dice mounted on the substrate.

The term “metallization” generally refers to metal layers formed over and through the dielectric material of the package substrate. The metal layers are generally patterned to form metal structures such as traces and bond pads. The metallization of a package substrate may be confined to a single layer or in multiple layers separated by layers of dielectric.

The term “bond pad” generally refers to metallization structures that terminate integrated traces and vias in integrated circuit packages and dies. The term “solder pad” may be occasionally substituted for “bond pad” and carries the same meaning.

The term “solder bump” generally refers to a solder layer formed on a bond pad. The solder layer typically has a round shape, hence the term “solder bump”.

The term “substrate” generally refers to a planar platform comprising dielectric and/or metallization structures. The substrate may mechanically support and electrically couple one or more IC dies on a single platform, with encapsulation of the one or more IC dies by a moldable dielectric material. The substrate generally comprises solder bumps as bonding interconnects on both sides. One side of the substrate, generally referred to as the “die side”, may comprise solder bumps for chip or die bonding. The opposite side of the substrate, generally referred to as the “land side”, may comprise solder bumps for bonding the package to a printed circuit board.

The term “assembly” generally refers to a grouping of parts into a single functional unit. The parts may be separate and are mechanically assembled into a functional unit, where the parts may be removable. In another instance, the parts may be permanently bonded together. In some instances, the parts are integrated together.

The terms “coupled” or “connected” means a direct or indirect connection, such as a direct electrical, mechanical, magnetic or fluidic connection between the things that are connected or an indirect connection, through one or more passive or active intermediary devices.

The term “circuit” or “module” may refer to one or more passive and/or active components that are arranged to cooperate with one another to provide a desired function. The term “signal” may refer to at least one current signal, voltage signal, magnetic signal, or data/clock signal.

1. An integrated circuit package, comprising:
a photonic integrated circuit (PIC) to send or receive optical signals, wherein the PIC comprises a first interface; and
an optical coupler to optically couple the PIC to one or more optical fibers, wherein the optical coupler comprises a second interface coupled to the first interface on the PIC;
wherein one of the first interface or the second interface comprises:
at least two recesses; and
one or more grooves positioned between the recesses;
wherein the other of the first interface or the second interface comprises:
at least two protrusions, wherein the protrusions are mated with the recesses; and
one or more ridges positioned between the protrusions, wherein the one or more ridges are mated with the one or more grooves.

2. The integrated circuit package of claim 1, wherein the one or more grooves and the one or more ridges are mated to align waveguides in the PIC with waveguides in the optical coupler.

3. The integrated circuit package of claim 2, wherein:
the first interface comprises the recesses and the one or more grooves; and
the second interface comprises the protrusions and the one or more ridges.

4. The integrated circuit package of claim 3, wherein the second interface further comprises a ledge, wherein the ledge comprises the protrusions and the one or more ridges, and wherein the ledge extends beyond the one or more ridges.

5. The integrated circuit package of claim 3, wherein:
the waveguides in the PIC extend to the one or more grooves; and
the waveguides in the optical coupler extend through the one or more ridges.

6. The integrated circuit package of claim 2, wherein:
the one or more grooves comprise a monolithic groove; and
the one or more ridges comprise a monolithic ridge.

7. The integrated circuit package of claim 2, wherein:
the one or more grooves comprise a plurality of grooves; and
the one or more ridges comprise a plurality of ridges.

8. The integrated circuit package of claim 7, wherein:
the plurality of grooves vary in size; or
the plurality of ridges vary in size.

9. The integrated circuit package of claim 1, further comprising polymer pads within the respective recesses.

10. The integrated circuit package of claim 1, wherein the one or more optical fibers are comprised in an optical cable, wherein the optical cable is configured to mate with the optical coupler.

11. The integrated circuit package of claim 1, further comprising an integrated circuit die, wherein the integrated circuit die is to communicate optically via the PIC, and wherein the integrated circuit die comprises processing circuitry, memory circuitry, storage circuitry, or communication circuitry.

12. A system, comprising:
a circuit board; and
an integrated circuit package electrically coupled to the circuit board, wherein the integrated circuit package comprises an optical interface, wherein the optical interface comprises:
a photonic integrated circuit (PIC) to send or receive optical signals, wherein the PIC comprises at least two recesses and one or more grooves positioned between the recesses; and
an optical coupler to optically couple the PIC to one or more optical fibers, wherein the optical coupler comprises at least two protrusions and one or more ridges positioned between the protrusions, wherein the protrusions are mated with the recesses on the PIC, and wherein the one or more ridges are mated with the one or more grooves on the PIC.

13. The system of claim 12, wherein the one or more ridges are mated with the one or more grooves to align waveguides in the optical coupler with waveguides in the PIC, wherein the waveguides in the optical coupler extend through the one or more ridges, and wherein the waveguides in the PIC extend to the one or more grooves.

14. The system of claim 13, wherein:
the one or more grooves comprise a monolithic groove; and
the one or more ridges comprise a monolithic ridge.

15. The system of claim 13, wherein:
the one or more grooves comprise a plurality of grooves; and
the one or more ridges comprise a plurality of ridges.

16. The system of claim 12, wherein the PIC further comprises polymer pads within the respective recesses.

17. The system of claim 12, wherein the integrated circuit package further comprises an integrated circuit die, wherein the integrated circuit die is to communicate optically via the optical interface, and wherein the integrated circuit die comprises processing circuitry, memory circuitry, storage circuitry, or communication circuitry.

18. The system of claim 12, wherein the system is comprised in a mobile device, a wearable device, a computer, a server, a video playback device, a video game console, a display device, a camera, or an appliance.

19. A device, comprising:
a photonic integrated circuit (PIC), wherein the PIC comprises:
at least two recesses on a surface of the PIC; and
one or more grooves on the surface of the PIC, wherein the one or more grooves are positioned between the recesses.

20. The device of claim 19, further comprising an electronic integrated circuit (EIC) conductively coupled to the PIC.
